(19) United States
(12) Patent Application Publication
(10) Pub. No.: US 2011/0105306 A1
(43) Pub. Date: May 5, 2011

(54) Method of Fabricating Cu-Zn-Al Catalyst for Producing Methanol and Dimethyl Ether

(75) Inventors: Chun-Ching Chien, Taipei (TW); Ning-Yih Hsu, Keelung (TW); Shean-Du Chiou, Taoyuan County (TW); Su-Hsine Lin, Taoyuan County (TW); Wan-Min Huang, Taoyuan County (TW)

(73) Assignee: ATOMIC ENERGY COUNCIL-INSTITUTE OF NUCLEAR ENERGY RESEARCH, Taoyuan County (TW)

(21) Appl. No.: 12/796,779

(22) Filed: Jun. 9, 2010

(30) Foreign Application Priority Data
Oct. 30, 2009 (TW) 098136794

(51) Int. Cl. B01J 29/072; B01J 21/02

(52) U.S. Cl. 502/75; 502/342

(57) ABSTRACT

A Cu—Zn—Al catalyst is fabricated for producing methanol and dimethyl ether (DME). A sol-gel method is used to obtain an organic phase with gel clusters rapidly transferred in. The catalyst thus fabricated can be adjusted in crystal grain size, crystal type, surface structure and active sites distribution. Thus, performance of the catalyst is improved.

### CROSS REFERENCE TO RELATED PATENT APPLICATIONS

This application claims priority from Taiwan Patent Application No. 098136794, filed in the Taiwan Patent Office on Oct. 30, 2009, entitled “Method of Fabricating Cu—Zn—Al Catalyst for Producing Methanol and Dimethyl Ether,” and incorporates the Taiwan patent application in its entirety by reference.

### TECHNICAL FIELD OF THE DISCLOSURE

The present disclosure relates to fabricating a catalyst; more particularly, relates to using a sol-gel method to improve performance of a nano-size catalyst by changing crystal grain size, crystal style, surface structure and distribution of active sites through composition change, gel precipitation and post-treatment, where the catalyst thus obtained has two active sites of methanol synthesis and methanol dehydration.

### DESCRIPTION OF THE RELATED ARTS

The molecular formula of dimethyl ether (DME) is CH₃OCH₃, whose physical properties are very similar to those of liquified petroleum gas (LPG) like propane and butane. DME can be liquefied at −25° C. or under 6 atmosphere pressures; and can be mixed into or replace LPG to be used at home or for commercial use. DME has ether odour so no extra odor gas is needed to be added, like natural gas or LPG; and its flame is very bright like methane's. LPG, natural gas and methanol are only fit to be used for ignition-type engines for their cetane numbers are all smaller than 10. But DME's cetane number is bigger than 55 and so DME is fit for compression-ignition-type engines and can be used as an alternative fuel with its good compression performance. DME is a liquified gas like LPG for neither sulfoxide (SO_{X}) nor greenhouse gases like nitroxide (NO_{X}) and carbon dioxide (CO₂) are generated on burning. Thus, DME is the best potential alternative fuel on comparing to methane, methanol, ethanol, FT-diesel, etc., no matter concerning greenhouse gas generated in a life cycle; energy efficiency; storage of non-fossil raw material; compatibility to non-petrochemical materials; or efficiency. Not to mention that DME has a low boiling point, a high oxygen content and a high cetane number, which can be used in fields of chemical raw material; chlorofluorocarbon (CFC) substitution compound; alternative fuel for diesel car; alternative fuel for home-use or commercial LPG; electricity generation by air turbine or diesel engine; and fuel used in fuel cell. Although DME can be fabricated from environment plasma syngas, a good catalyst is necessary for economical production.

As shown in FIG. 6, there are two methods for fabricating DME, including a one-step method and a two-step method. The one-step method uses a reactor to from DME from syngas; and the two-step method uses a reactor to from methanol from syngas or natural gas and then uses another reactor to form DME from methanol. No matter for the one-step method or the two-step method, syngas is required at first. Natural gas can be processed through a steam reforming reaction at first to obtain syngas and then to further form DME from syngas. Coal or bio-materials can be gasified to obtain syngas and then to further form DME from syngas. Or, environment plasma syngas can be directly used to form DME. The two-step method is the main method for fabricating DME in the market now. For the two-step method, a copper series catalyst is used to form methanol from syngas at first; then, an aluminum (Al) series catalyst or a zeolite series catalyst is used to form DME through methanol dehydration. In the other hand, a newly disclosed one-step method simultaneously processes methanol synthesis and methanol dehydration in a single reactor for forming DME by converting methanol once after methanol is formed in the reactor. In this way, a DME conversion rate better than that for the two-step method is obtained.

In the above stated one-step method, syngas is processed through a series of reactions to form DME by rapidly dehydrating methanol. Hence, not only reaction driving force is increased, but also thermodynamical equilibrium limitation is broken through; and, the conversion rate for forming DME becomes higher than that for obtaining methanol only. Concerning Gibbs free energy for forming methanol and that for forming DME, at a catalyst active temperature between 150 and 300° C., the Gibbs free energy for forming DME is between −10 and 13 kilo-joule per mole (kJ/mol); and that for forming methanol is between 2 and 18 kJ/mol, which is bigger than that for forming DME and the reaction driving force for forming DME is increased. When the temperature is raised to 380° C., both the Gibbs free energy for forming methanol and that for forming DME are about 24 kJ/mol. But, when the temperature is raised above 380° C., the Gibbs free energy for forming methanol becomes smaller than that for forming DME and the reaction driving force for forming DME becomes weak—which may turn to that for forming methanol. Regarding the conversion rate, the carbon monoxide (CO) equilibrium conversion for forming DME is higher than that for forming methanol at a temperature between 100 and 400° C. Hence, the one-step method is more suitable for forming DME than methanol. At a catalyst active temperature between 150 and 300° C., the temperature obviously influences reactions on forming DME. When the temperature rises, the CO equilibrium conversion soon becomes slow. At a temperature between 200 and 400° C., pressure obviously influences the reactions. When the pressure is increased, the CO equilibrium conversion quickly becomes fast. Regarding composition, when a mole value of H₂/CO (a raw material) is raised to 2, the CO equilibrium conversion is not increased. When the mole value of H₂/CO is raised to 3, the CO equilibrium conversion is the same as that for when the mole value of H₂/CO is 2. Conclusively, a preferred environment for forming DME from syngas includes a low temperature, a high pressure and a proper syngas composition.

There are three mutually related reactions for forming DME from syngas, including methanol synthesis, methanol dehydration and water gas shift reaction, whose reaction equations are as follows:

4H₂+2CO->2CH₃OH (1)

(methanol synthesis)

2CH₃OH->CH₃OCH₃+H₂O (2)

(methanol dehydration)

CO+H₂O->CO₂+H₂ (3)

(water gas shift reaction)

3CO+3H₂->CH₃OCH₃+CO₂ (4)

(total reaction)

According to the reaction process for forming DME from syngas, synthesis catalyst for forming DME must be suitable for methanol synthesis, methanol dehydration and water gas shift reaction, which means there must be suitable active sites in the catalyst. Prior arts for fabricating such catalyst include mechanical mixing for complex catalyst; and specific chemical synthesis for multi-functional catalyst.

Regarding complex catalyst, the process for mechanical mixing is simple and different conditions for processing two or three catalysts and interferences among them can be avoided. Furthermore, content ratios of the catalysts can be adjusted as needed be to achieve balance; and the adjustment is suitable for selecting catalyst active material and for researching catalyst reaction mechanism.

For catalysts in a fixed-bed reactor, dry mixing method and wet mixing method can be used. The dry mixing method directly fully processes the mechanical mixing through stirring without adding any solvent. Yet, the catalyst obtained its shape after compressing has low mechanical intensity. In the other hand, the wet mixing method uses a little inert volatile liquid to be added before mixing through stirring; then, it is fully mixed to obtain a plaster-like material; and, then, it is hot-dried to evaporate liquid part within. The advantage of this method is that the catalyst is fully mixed; but the disadvantage is that solvent can not be fully removed and the remaining liquid part may affect reduction reaction of the catalyst.

For forming catalyst in a slurry bed reactor, catalyst is put into a reactor for mixing through only a little simple stirring. Catalyst will uniformly floated on an inert medium by power of stirring or bubbling to fully mix complex catalyst.

In U.S. Pat. No. 4,423,155, Chang and Bell disclosed a complex catalyst composed of methanol catalyst and aluminum trioxide (γ-Al₂O₃), where the methanol catalyst is synthesized with copper (Cu), zinc (Zn) and aluminum (Al). They revealed a DME directly formed from syngas, where catalyst is regenerated at a temperature between 250 and 400° C. Recently, more and more researches focus on using molecular sieves to form methanol catalyst and dehydration catalyst for directly forming DME from syngas. Those researches find that the sites of strong acidity and weak acidity on the molecular sieves have different effects on forming DME. Only the active site of weak acidity and proper active site of alkalinity on the molecular sieve help forming DME. On the contrary, active site of strong acidity further dehydrates methanol or DME into alkanes and thus reduces selectivity on forming DME.

This kind of catalyst is obtained by grinding two or three catalysts to be processed through mechanical mixing with certain ratios. According to the above mentioned reaction equation (1), (2) and (3), three catalysts are required, including a catalyst for methanol synthesis, that for methanol dehydration and that for water gas shift reaction. Therein, if the water gas shift reaction is ignored, the prior two reactions can be considered as continuous reactions; and if any one of the prior two reactions is not good enough, speed of the whole reactions may be limited. Although the complex catalyst can be obtained from a catalyst having a single active site of methanol synthesis and a catalyst having a single active site of methanol dehydration through mechanical mixing, the complex catalyst thus made would not have good contribution of the active sites.

For fabricating a multi-functional catalyst, at least two effective catalyst active sites are directly tightly formed in pores of a supporter through special chemical synthesis methods. Because different effective catalyst active sites can be more tightly bound and their effects to mass transfer like convection and diffusion are reduced, selectivity of DME and conversion of the whole process are heightened. Hence, cupric nitrate or zinc nitrate can be loaded on γ-Al₂O₃.

Co-precipitation method and sol-gel method are most effective methods for fabricating DME. But, most of the time, DME is fabricated at a temperature between 250 and 280° C., which is higher than the theoretical temperatures for methanol synthesis and methanol dehydration. Hence, the activity of the catalyst is weakened and the two active sites do not perform their best. Thus, not only the reactions are limited thermodynamically, but also life time of CO used in conversion for unstable Cu-based catalyst is shortened.

As shown above, forming DME from syngas through the one-step method is better than through the two-step method in aspects of conversion and cost. The key for directly forming DME from environment plasma syngas is catalyst. According to reaction mechanism, catalyst used in forming DME from syngas through the one-step method must have functions for methanol synthesis and methanol dehydration. The catalysts are divided into complex catalysts and multi-functional catalysts according to their function and fabrication method. Therein, the complex catalysts are obtained through mechanical mixing from a catalyst for methanol synthesis and that for methanol dehydration. Therein, the catalyst for methanol synthesis is a Cu-based catalyst; dehydrator used contains an acid molecular sieve and γ-Al₂O₃; and the processes comprises staving, precipitating, washing, filtering, drying, pelleting and forming. The ratios of the catalysts are essential for forming DME from syngas. Furthermore, aluminium phosphate (AlPO₄) can be added into the dehydrator to help processing methanol dehydration and to be effectively bound with the catalyst for methanol synthesis to prolong life time of the catalyst. However, the procedure for complex catalyst is complex and the facilities used are many; and thus low-temperature activity, selectivity and stability of catalyst are hard to be effectively improved. Hence, the prior arts do not fulfill all users' requests on actual use.

### SUMMARY OF THE DISCLOSURE

The main purpose of the present disclosure is to provide a micro-particle-size Cu—Zn—Al catalyst having two active sites of methanol synthesis and methanol dehydration.

The second purpose of the present disclosure is to improve performance of a catalyst by changing crystal grain size, crystal style, surface structure and distribution of active sites through composition change, gel precipitation and post-treatment, where the catalyst thus obtained has two active sites of methanol synthesis and methanol dehydration.

To achieve the above purposes, the present disclosure is a method of fabricating a Cu—Zn—Al catalyst for producing methanol and DME, comprising steps of: (a) obtaining an ethanol solution having a salt containing catalytic activity ingredients; (b) obtaining a microporous solid support having dehydration activity; (c) stirring the ethanol solution and the solid support together to obtain a mixed solution and slowly dropping an ethanol solution having oxalic acid to process precipitation and obtain oxalate particles of oxalic acid; (d) putting the solid support into a vacuum condensing environment to remove ethanol through vacuum evaporation; (e) putting the solid support into a furnace to process calcination to precipitate and remove the oxalic acid through high temperature calcination; (f) cooling the solid support down; (g) putting the solid support into a furnace having a hydrogen environment to process high temperature calcination for removing oxygen atoms and reducing metal catalyst particles; and (h) processing the solid support through sheeting, staving and sieving. Accordingly, a novel method of fabricating a Cu—Zn—Al catalyst for producing methanol and DME is obtained.

### BRIEF DESCRIPTIONS OF THE DRAWINGS

The present disclosure will be better understood from the following detailed description of the preferred embodiment according to the present disclosure, taken in conjunction with the accompanying drawings, in which

FIG. 1 is the flow view showing the preferred embodiment according to the present disclosure;

FIG. 2 is the view showing the XRD diagram of the Cu—Zn—Al catalyst;

FIG. 3 is the view showing the production distributions of the syngases;

FIG. 4 is the view showing the production curves of the syngases;

FIG. 5 is the view showing the selectivity curve; and

FIG. 6 is the flow view of the DME production.

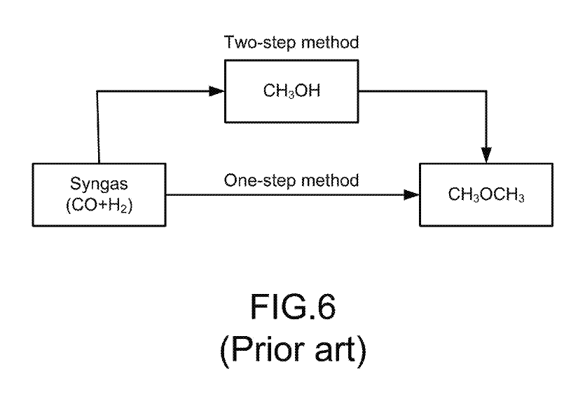

### DESCRIPTION OF THE PREFERRED EMBODIMENT

The following description of the preferred embodiment is provided to understand the features and the structures of the present disclosure.

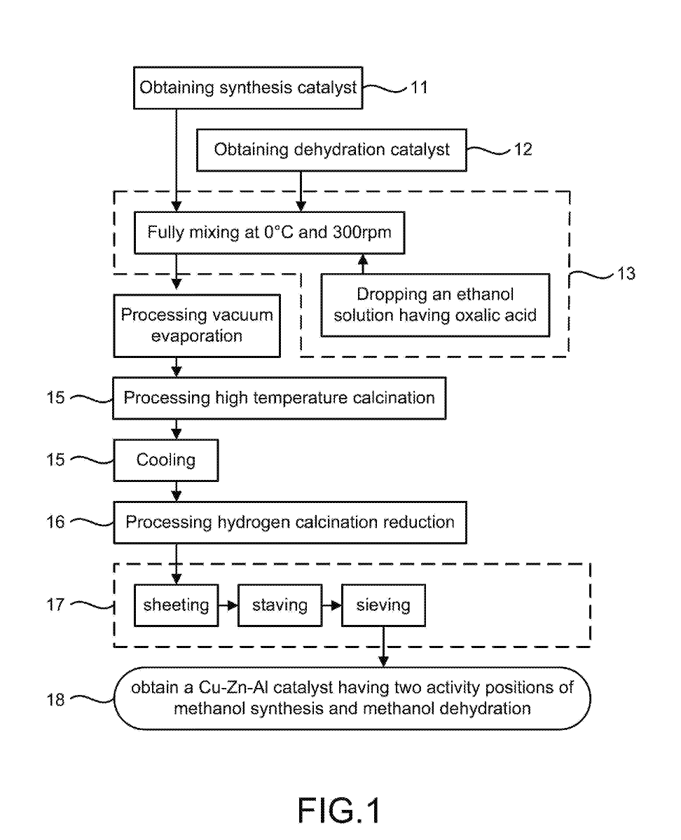

Please refer to FIG. 1, which is a flow view showing a preferred embodiment according to the present disclosure. As shown in the figure, the present disclosure is a method of fabricating a Cu—Zn—Al catalyst for producing methanol and dimethyl ether (DME), where a solvent and a surfactant are used to form an organic phase through a sol-gel method, where the organic phase is not mutually dissolved with a mixed salt solution. Owing to changes in surface tension after the gel is formed, colloid particles obtained during the fabrication are swiftly moved into the organic phase to obtain an isolation function to the gel and to avoid aging again and to avoid enlarging during drying; and, thus, a nano-catalyst having a micro particle size is fabricated. The present disclosure comprises the following steps:

(a) Obtaining synthesis catalyst 11: An ethanol solution having a salt containing catalytic activity ingredients is obtained, where the catalytic activity ingredients comprise copper (Cu), zinc (Zn) and aluminum (Al) or comprise Cu and Zn; and the catalytic activity ingredients have active sites of carbon monoxide (CO) and hydrogen (H₂).

(b) Obtaining dehydration catalyst 12: A microporous solid support having dehydration activity is obtained, where the solid support has active sites of dehydration activity; the solid support is a molecular sieve, aluminum trioxide (γ-Al₂O₃), or a silica-aluminum compound; and the molecular sieve is zeolite (ZSM-5).

(c) Stirring to obtain production particles 13: The ethanol solution and the solid support are stirred together at a temperature between −5° C. and 4° C. Then, an ethanol solution having oxalic acid is slowly dropped for precipitation to obtain oxalate particles of oxalic acid tightly combined with the solid support.

(d) Processing vacuum evaporation 14: The solid support is put into a vacuum condensing environment to remove ethanol through vacuum evaporation.

(e) Processing high temperature calcination 15: The solid support is put into a furnace for high temperature calcination at a temperature of 500±10° C. to precipitate and remove the oxalic acid.

(f) Cooling said solid support down 16: The solid support is cooled down.

(g) Processing hydrogen calcination reduction 17: The solid support is put into a furnace having a hydrogen environment for high temperature calcination at a temperature of 400±10° C. to remove oxygen atoms combined in the solid support and to reduce metal catalyst particles, like Cu, Zn or Al, combined in the solid support.

(h) Processing physical process treatments 18: The solid support is processed through physical process treatments of sheeting, staving and sieving to obtain a Cu—Zn—Al catalyst having two activity positions of methanol synthesis and methanol dehydration.

Thus, the catalyst fabricated according to the present disclosure obtains improved performance by changing crystal grain size, crystal style, surface structure and distribution of active sites through composition change, gel precipitation and post-treatment.

On using the present disclosure, a molecular sieve is used, like ZSM-5. The molecular sieve is stirred with an ethanol solution having a salt containing catalytic activity ingredients, like Cu, Zn, etc. By stirring, the ethanol solution takes time to be permeated into pores of the molecular sieve. Then, an ethanol solution having oxalic acid is slowly dropped in at 0° C. with stirring at a velocity of 300 rpm. Thus, oxalate particles are formed from the oxalic acid in the ethanol solution to avoid big particles in precipitation. Then, the molecular sieve is put into a vacuum condensing environment for removing ethanol. The molecular sieve is then processed through calcination at 500° C. to remove the organic part of oxalic acid in the molecular sieve loaded with CuO and ZnO. After being cooled down, the molecular sieve is processed through calcination reduction in an environment of hydrogen to remove catalyst particles of Cu and Zn in the molecular sieve. In the end, after physical processes of sheeting, staving and sieving, a Cu—Zn-ZSM5 catalyst having nano-size particles is obtained through a sol-gel method.

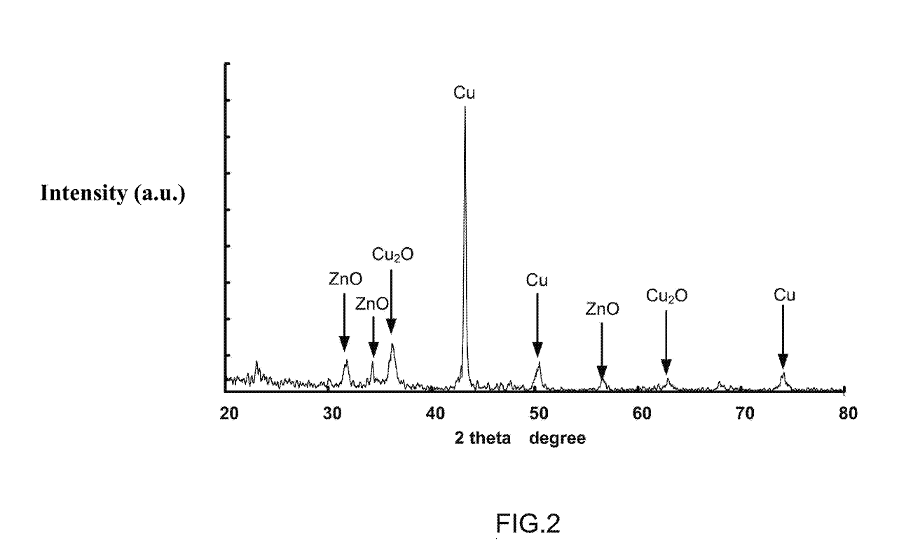

Please refer to FIG. 2, which is a view showing an X-ray diffraction (XRD) diagram of a Cu—Zn—Al catalyst. As shown in the figure, in a Cu—Zn-ZSM5 catalyst obtained after hydrogen calcination reduction according to the present disclosure, Cu is an active ingredient which has a better intensity then the others.

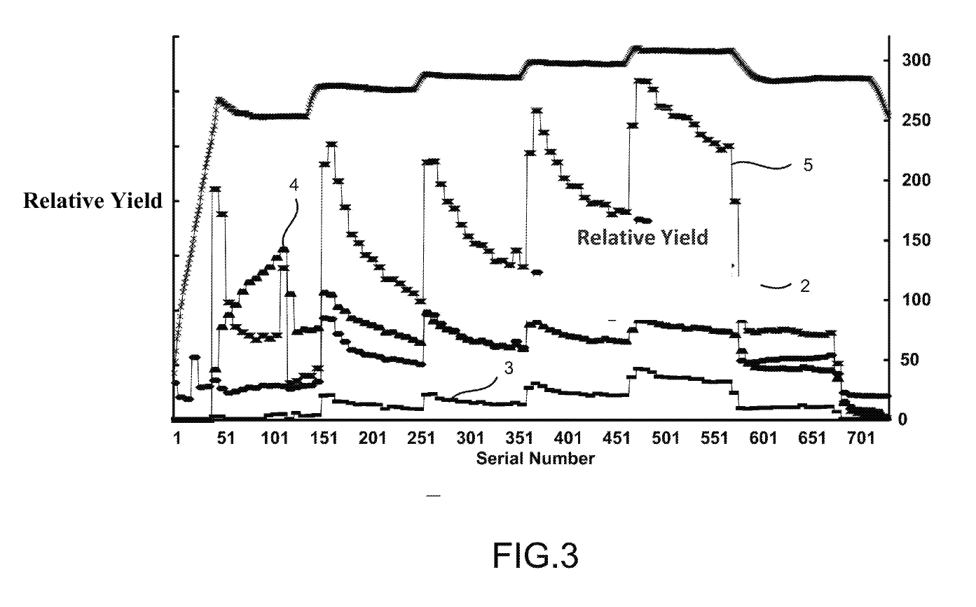

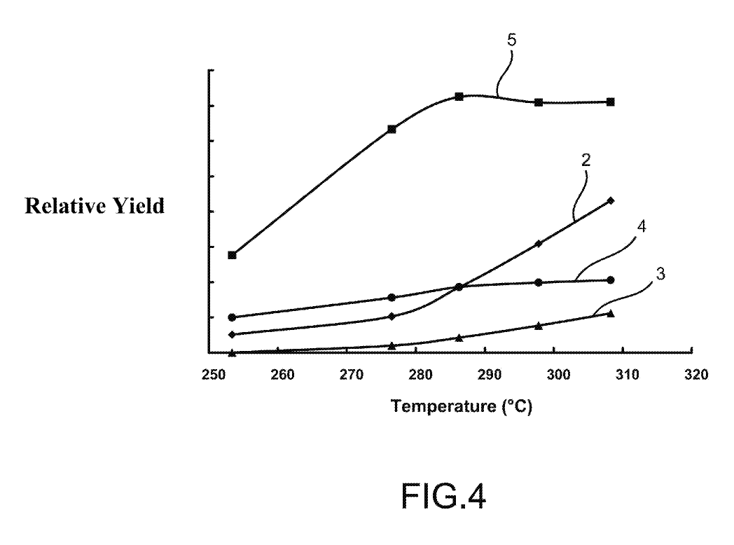

Please refer to FIG. 3 and FIG. 4, which are views showing production distributions and production curves of syngases. As shown in the figures, productions are fabricated according to the present disclosure to form a methane production curve 2, an ethane production curve 3, methanol production curve 4 and a DME production curve 5. It shows that DME and methanol can be obtained from syngas with a Cu—Zn-ZSM5 catalyst fabricated according to the present disclosure, where byproducts for DME are mostly methane and ethane and are increased after temperature is heightened (>250° C.).

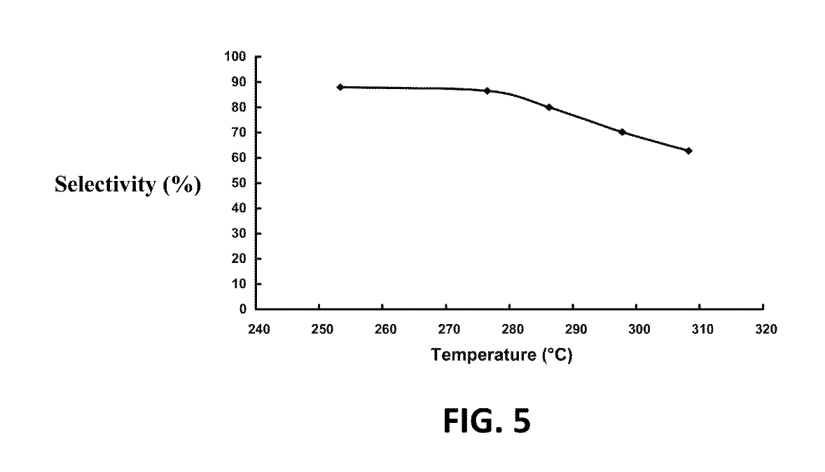

Please refer to FIG. 5, which is a view showing a selectivity curve. As shown in the figure, temperature for fabrication according to the present disclosure is changeable for selectivity. Therein, a preferred temperature for DME is between 250 and 280° C. to obtain selectivity greater than 85%, which is the best selectivity for DME.

Accordingly, a multi-functional catalyst fabricated according to the present disclosure has two active sites of methanol synthesis and methanol dehydration, which are tightened together and are not mutually blocked; and activity of the catalyst is thus improved. Hence, in reactions for directly forming DME from syngas, a dehydration reaction is happened at sites of dilute acid, which means more sites of dilute acid obtains higher catalyst activity and product selectivity. In the other hand, the multi-functional catalyst fabricated according the present disclosure has good synergistic effect. The existence of the acid dehydration compound makes active site of methanol synthesis become vivid; and the existence of the active site of methanol synthesis increases strength of acidity at site of dilute acidity of the acid dehydration compound, which further improves dehydration performance of the catalyst. Thus, the present disclosure relatively increases conversion of the whole reactions and reaction selectivity of DME; and effectively reduces cost.

To sum up, the present disclosure is a method of fabricating a Cu—Zn—Al catalyst for producing methanol and DME, where a sol-gel method is used to improve performance of a nano-size catalyst by changing crystal grain size, crystal style, surface structure and distribution of active sites through composition change, gel precipitation and post-treatment; and the catalyst thus obtained has two active sites of methanol synthesis and methanol dehydration.

The preferred embodiment herein disclosed is not intended to unnecessarily limit the scope of the disclosure. Therefore, simple modifications or variations belonging to the equivalent of the scope of the claims and the instructions disclosed herein for a patent are all within the scope of the present disclosure.

What is claimed is:

1. A method of fabricating a Cu—Zn—Al catalyst for producing methanol and dimethyl ether, the method comprising:
obtaining an ethanol solution having a salt containing catalytic activity ingredients;
obtaining a microporous solid support having dehydration activity;
stirring said ethanol solution and said solid support together at a temperature between −5 and 4° C. and slowly dropping an ethanol solution having oxalic acid to process precipitation and to obtain oxalate particles of oxalic acid tightly combined with said solid support;
putting said solid support into a vacuum condensing environment to remove ethanol through vacuum evaporation;
putting said solid support into a furnace to process calcination to precipitate and remove said oxalic acid through high temperature calcination;
cooling said solid support down;
putting said solid support into a furnace having a hydrogen environment to process high temperature calcination at a temperature of 400±10° C. to remove oxygen atoms combined in said solid support and to reduce metal catalyst particles combined in said solid support; and
processing said solid support through physical process treatments of sheeting, staving and sieving to obtain a Cu—Zn—Al catalyst having two activity positions of methanol synthesis and methanol dehydration.

2. The method according to claim 1, wherein, in obtaining an ethanol solution having a salt containing catalytic activity ingredients, said catalytic activity ingredients comprises copper (Cu), zinc (Zn) and aluminum (Al) and said catalytic activity ingredients have active sites of carbon monoxide (CO) and hydrogen (H₂).

3. The method according to claim 1, wherein, in obtaining an ethanol solution having a salt containing catalytic activity ingredients, said catalytic activity ingredients comprises Cu and Zn and said catalytic activity ingredients have active sites of CO and H₂.

4. The method according to claim 1, wherein;
in obtaining a microporous solid support having dehydration activity, said solid support is selected from a group consisting of a molecular sieve, aluminum trioxide (γ-Al₂O₃) and a silica-aluminum compound; and said solid support has active sites of dehydration activity.

5. The method according to claim 4, wherein, in obtaining an ethanol solution having a salt containing catalytic activity ingredients, said molecular sieve is zeolite.

6. The method according to claim 1, wherein, in stirring said ethanol solution and said solid support together at a temperature between −5 and 4° C. and slowly dropping an ethanol solution having oxalic acid, said stirring is processed at a temperature above 0° C. and a rotation velocity greater than 300 rpm.

7. The method according to claim 1, wherein, in putting said solid support into a furnace to process calcination to precipitate and remove said oxalic acid through high temperature calcination, said high temperature calcination is processed at a temperature of 500±10° C.

8. The method according to claim 1, wherein said metal catalyst particles are Cu catalyst particles.

9. The method according to claim 1, wherein said metal catalyst particles are Zn catalyst particles.

10. The method according to claim 1, wherein said metal catalyst particles are Al catalyst particles.
